(19) United States
(12) Patent Application Publication
(10) Pub. No.: US 2025/0091919 A1
(43) Pub. Date: Mar. 20, 2025

(54) METHOD AND SYSTEM FOR WATER TREATMENT USING MODIFIED ADVANCED OXIDIZING TECHNOLOGY

(71) Applicant: Apichet Ponglikhittanon, Maung Chonburi (TH)

(72) Inventor: Apichet Ponglikhittanon, Maung Chonburi (TH)

(21) Appl. No.: 18/726,690

(22) PCT Filed: Jan. 19, 2022
(86) PCT No.: PCT/IB2022/050422

§ 371 Date: Jul. 3, 2024

(51) Int. Cl. C02F 1/72; C02F 1/00; C02F 1/24; C02F 1/32; C02F 3/02; C02F 9/00

(52) U.S. Cl. CPC C02F 1/725; C02F 1/325; C02F 1/722; C02F 9/00; C02F 1/004; C02F 1/24; C02F 3/02; C02F 2305/023; C02F 2305/10

(57) ABSTRACT

A method for a water treatment using a modified advanced oxidizing technology. The method comprises generating reactive oxygen species and receiving a water and the generated reactive oxygen species into a catalytic reactor (206) for treating water. A system for a water treatment using a modified advanced oxidizing technology. The system (200) comprises a supply of water (202), an oxidization chamber (204) for generating reactive oxygen species; and a catalytic reactor (206), operatively coupled to the supply of water (202) and the oxidization chamber (204), for receiving the water and the generated reactive oxygen species for treating the water. Moreover, the system (200) comprises a dissolved air flotation arrangement (208), coupled to the supply of water (202), for pre-treating supplied water using a dissolved air flotation technique.

### TECHNICAL FIELD

The present disclosure relates generally to water treatment; and more specifically, to methods for water treatment using modified advanced oxidizing technology. The present disclosure also relates to systems for water treatment using modified advanced oxidizing technology.

### BACKGROUND

Over past decades, the increase in population has resulted in increased water consumption. While the water resources remain constant, there is a need to recycle and reuse the water currently on the water cycle. It will be appreciated that water currently on the water cycle may contain contaminants such as human waste, industrial waste, food scraps, oils, soaps, chemicals, dissolved gases, microbial load, and other contaminants such as VOCs, NH₃, H₂S, SO₂ and NOₓ, and so forth, thereby making the water difficult for consumption by human beings, animals and aquatic biota. Therefore, the water requires treatment to remove contaminants therefrom and convert it into reusable water for various purposes.

Conventionally, there are many types of water treatment methods which could be classified as physical, biological, or chemical processes. For more efficiency, a combination of the said methods can be applied. Physical treatment is a separation of the solid materials from the water by such as filtration e.g. sieve drum and sand collector, and the like. Biological wastewater treatments rely on bacteria, nematodes, or other small organisms to decompose organic wastes, such as carbon-containing substances, into harmless or volatile compounds. Biological treatment usually is divided into aerobic and anaerobic processes. “Aerobic” refers to a process in which oxygen is present, while “Anaerobic” refers a condition of biological process in an oxygen-free environment. Typically, biological treatment uses microbes to feed on the organic waste in which a special care like pH and aeration should be monitored to sustain the microbes' activities and efficiency of the process. There are several chemical wastewater treatment processes such as chemical precipitation, ion exchange, neutralization, adsorption and disinfection (using chlorination/dichlorination, ozone, ultraviolet radiation, etc.). Due to high cost of chemical additives and the environmental problem of disposing large amounts of chemical sludge make this treatment process inefficient and ineffective.

Recently, an Advanced Oxidation Process (AOP) is used for wastewater treatment. Typically, AOP uses the hydroxyl radicals for the removal of organic contaminants in wastewater and to convert contaminants into stable inorganic compounds such as water, carbon dioxide and salts undergoing mineralization. The benefits of AOP over other conventional method are quick reaction and require small installation area because of oxidation power of hydroxyl radical, able to remove many different contaminants in one reactor vessel including reducing a few heavy metals, capable to act as a disinfection especially when used with UV disinfection, and less or no sludge production as with biological or other conventional chemical processes. Due to several benefits as mentioned above, AOP becomes more and more acceptable for waste water treatment. However, the conventional AOPs are limited by major factors i.e. high investment cost and high operation cost as well as hydroxyl residue should be considered to be removed after treatment process. Therefore, the conventional AOPs are difficult to be applied industrially on a large scale.

Therefore, in light of the foregoing discussion, there exists a need to overcome the aforementioned drawbacks associated with conventional water treatment.

### SUMMARY

The present disclosure seeks to provide a method for a water treatment using a modified advanced oxidizing technology. The present disclosure also seeks to provide a system for a water treatment using a modified advanced oxidizing technology. The present disclosure seeks to provide a solution to the existing problem of water treatment. An aim of the present disclosure is to provide a solution that overcomes at least partially the problems encountered in the prior art, and provides an efficient, robust, environmentally friendly, energy-saving, and cost-efficient water treatment process.

In one aspect, an embodiment of the present disclosure provides a method for a water treatment using a modified advanced oxidizing technology, the method comprising:
generating reactive oxygen species; and
receiving a water and generated reactive oxygen species into a catalytic reactor for treating water.

In another aspect, an embodiment of the present disclosure provides a system for a water treatment using a modified advanced oxidizing technology, the system comprising:
a supply of water;
an oxidization chamber for generating reactive oxygen species; and
a catalytic reactor, operatively coupled to the supply of water and the oxidization chamber, for receiving the water and the generated reactive oxygen species for treating the water.

Embodiments of the present disclosure substantially eliminate or at least partially address the aforementioned problems in the prior art, and enable efficient treatment of water by eliminating the organic and inorganic substances, toxins and other dissolved impurities from the water. In this regard, the water is subjected to reactive oxygen species that are generated separately to make the reaction more efficient. Moreover, the reaction between the water and reactive oxygen species occur in the presence of catalysts arranged as a packed-bed catalyst. Beneficially, the packed-bed catalyst eliminates the need to filter and recycle the catalysts during the water treatment resulting in lower operating costs.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart depicting steps of a method for a water treatment using a modified advanced oxidizing technology, in accordance with an embodiment of the present disclosure;

FIG. 2 is a schematic illustration of a system for a water treatment using a modified advanced oxidizing technology, in accordance with an embodiment of the present disclosure; and

FIG. 3 is a schematic illustration of a catalytic reactor, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible. In one aspect, an embodiment of the present disclosure provides a method for a water treatment using a modified advanced oxidizing technology, the method comprising:
generating reactive oxygen species; and
receiving a water and the generated reactive oxygen species into a catalytic reactor for treating water.

In another aspect, an embodiment of the present disclosure provides a system for a water treatment using a modified advanced oxidizing technology, the system comprising:
a supply of water;
an oxidization chamber for generating reactive oxygen species; and
a catalytic reactor, operatively coupled to the supply of water and the oxidization chamber, for receiving the water and the generated reactive oxygen species for treating the water.

The present disclosure provides the aforementioned method and the aforementioned system for the water treatment using the modified advanced oxidizing technology. The method employs a combination of actions to clean the water to enhance the reusability thereof. In this regard, the method comprises generating reactive oxygen species separately and then feeding the generated reactive oxygen species and water into a catalytic reactor, having oxidation and reduction catalysts arranged as packed-bed catalysts, for treating water. Beneficially, the packed-bed catalysts increase retention time and interaction contact between the water and the reactive oxygen species. Additionally, beneficially, the packed-bed catalysts will not be lost or flushed away during said process leading to longer service life of catalyst and better consistency of the reaction. Moreover, the method comprises diffusing, via a diffuser, the generated reactive oxygen species into the catalytic reactor to increase retention time and interaction contact owing to the increased surface area of the micro- or nano-bubbles of the reactive oxygen species. Furthermore, the method comprises subjecting the water to a series of dissolved air flotation arrangement, an aerobic reactor, additional hydrogen peroxide for effectively treating the water.

It will be appreciated that water may be supplied from a natural source of water or maybe used water from a variety of applications such as domestic, industrial, commercial, agricultural, surface runoff, stormwater, sewer infiltration water, and so forth. Typically, such water may contain contaminants, such as constituents of physical, chemical, and biological nature. Optionally, the physical contaminants may be presented in the form of suspended solids such as floating matter, settleable matter, colloidal matter, and the like. Optionally, the chemical contaminants may be lignocellulose, cellulose, proteins, fats, inorganic particulate matter in a suspended state, and sugars, fatty acids, alcohols, amino acids, and the like in the soluble form. Optionally, the chemical constituents may include gases, namely, sulphur dioxide (SO₂), ammonia (NH₃), methane (CH₄), carbon monoxide (CO), hydrogen sulphide (H₂S), volatile organic compounds (VOCs), and other heavy metals such as zinc (Zn), chromium (Cr), nickel (Ni), lead (Pb), phosphorus (P), and so forth. Optionally, the biological contaminants may be microorganisms, such as fungi, bacteria (such as coliforms, streptococci, clostridia, micrococci, proteus, pseudomonas, and lactobacilli), protozoa, and so on.

The term “water treatment” as used herein refers to a process of removing contaminants from water for subsequent consumption thereof by humans, animals or plants. In other words, the water treatment may also refer to a purification process to free water of impurities, thereby making the water reusable. Typically, the water treatment use processes such as physical processes (such as sedimentation), biological processes, chemical processes, and so forth. Additionally, the water treatment processes may generate by-products such as sludge, biogas, colour and so forth. Typically, the treatment process takes place in a dedicated space, referred to as a water treatment plant. It will be appreciated that the water treatment plants may vary based on the hardness of water that requires treatment (or purification). In an example, the water treatment plant for treating municipal wastewater or sewage is called a sewage treatment plant. Similarly, there may be an industrial wastewater treatment plant, an agricultural water treatment plant, a swimming pool water treatment plant, a leachate treatment plant, and so forth. Beneficially, the water treatment prevents water pollutants from being discharged into the environment.

The term “advanced oxidizing technology” (or advanced oxidation process) as used herein refers to a chemical treatment technology that employs advanced oxidization processes for removing organic and/or inorganic compounds present in water, such as wastewater, through reactions with hydroxyl radicals (OH—) for producing clean water. The hydroxyl radicals can be produced from at least one of: ozone (O₃), oxygen, a hydrogen peroxide (H₂O₂), in the presence of at least one of a UV light and catalysts. In this regard, the organic and inorganic compounds may be transformed into simple stable compounds such as water, carbon dioxide, and salts with little or no sludge production, thereby eliminating the need for further treatment (downstream processing). Moreover, the advanced oxidizing technology works in three phases, namely the formation of the hydroxyl radicals, initial attack on target molecules by the hydroxyl radicals to break down the organic and inorganic compounds into fragments, and subsequent attack by the hydroxyl radicals until ultimate mineralization of the wastewater. Beneficially, the advanced oxidizing technology may reduce the concentration of contaminants from parts per million (ppm) to be in a level of parts per billion (ppb), thereby significantly reducing the chemical oxygen demand (COD) and the total organic carbon (TOC) in the wastewater. Beneficially, the advanced oxidizing technology results in the complete reduction of the organic or inorganic compounds present in water by the hydroxyl radicals into water molecules (H₂O).

Pursuant to the embodiments of the present disclosure, the method comprises generating reactive oxygen species. The term “reactive oxygen species” as used herein refers to highly reactive chemicals formed from oxygen (O₂). Typically, reactive oxygen species operate via one-electron oxidation (radical ROS species) or two-electron oxidation (non-radical ROS species). The ROS may either be generated by biochemical reactions exogenously (such as stimulated by ultraviolet light, ionizing radiation, and pollutants) or endogenously (in organelles such as mitochondria, chloroplasts and peroxisomes). In an example, the pollutants (such as methyl viologen) react to form either peroxides or ozone; chemicals that promote the formation of superoxide (such as quinones, nitroaromatics, and bipyrimidiulium herbicides); chemicals that are metabolized to radicals, (such as polyhalogenated alkanes, phenols, aminophenol); or chemicals that release iron and copper that could promote the formation of hydroxyl radicals. Beneficially, the ROS are generated, in a separate process, before feeding the water into a catalytic reactor to save operational cost and increase the efficiency of the method.

Optionally, the reactive oxygen species is at least one of: Superoxide anion, Hydroxyl radical, Hydroxyl ion, Peroxyl radical, Alkoxyl radical, Hydroperoxyl radical, Perhydroxyl radical, Peroxide radical, Hydrogen peroxide, Singlet oxygen. Optionally, the ROS are mainly oxidizing agents that can oxidize other chemical elements by accepting the electrons therefrom. The hydroxyl radicals are extremely reactive and nonselective with the organic compounds present in the water. Optionally, the reactive oxygen species may act as a reducing agent as well depending upon the oxidation state thereof. In an example, hydrogen peroxide may act both as an oxidizing agent and a reducing agent. The Superoxide anion (O₂·⁻) is produced by the one-electron reduction of molecular oxygen. In aqueous media, protonation of superoxide can form the uncharged hydroperoxyl radical (HOO·). The Superoxide anion is used to provide a readily available source of oxygen and is a better reducing agent than an oxidizing agent. The hydrogen peroxide is a closed-shell molecule resulting from the one-electron reduction of O₂⁻. Moreover, the reduction of hydrogen peroxide, in turn, yields the hydroxyl radical (OH^{·}) that undergoes reduction to yield water (or hydroxide OH—). Optionally, the ROS may be generated using a Fenton reaction that enables hydrogen peroxide (H₂O₂) to produce free radicals when the catalyst is added or injected. The free radicals such as hydroxyl radical may react with the organic compounds around the injection point and the influence area. Optionally, the strong oxidizing agent such as Persulfate, activated by ferrous iron for sulphate radicals, may be applied to remediate the enormous organic compounds present in the water. The term “singlet oxygen” as used herein refers to a gaseous inorganic chemical with the formula O═O (¹O₂). Singlet oxygen is a strong oxidant and is far more reactive toward organic compounds. Furthermore, the Peroxy radicals possess a low oxidizing ability as compared to hydroxyl radical but comprise a high diffusibility of the reactant molecules in the catalytic reaction. Additionally, the alkoxyl radicals have intermediate reactivity between the hydroxyl radical and the Peroxy radical. Typically, Superoxide (O₂·⁻), Hydroxyl (OH·), Peroxyl (RO₂·), Alkoxyl (RO·), Hydroperoxyl (HO₂·), Nitric oxide (NO·) and Nitrogen dioxide (NO₂·) are the radical species. Typically, Hydrogen peroxide (H₂O₂), Hypochlorous acid (HOCl⁻), Ozone (O₃), Singlet oxygen (¹O₂), Peroxynitrite (ONOO⁻), Alkyl peroxynitrites (ROONO), Dinitrogen trioxide (N₂O₃), Dinitrogen tetroxide (N₂O₄), Nitrous acid (HNO₂), Nitronium anion (NO₂⁺), Nitoxyl anion (NO⁻), Nitrosyl cation (NO⁺), and Nitryl chloride (NO₂Cl) are the non-radical species.

Moreover, the method comprises receiving the water and the generated reactive oxygen species into the catalytic reactor for treating water. In this regard, the water is received from a supply of water, such as a reservoir pump station pumping the water for the water treatment. Optionally, alternatively, the supply of water may be a river, an underground tank, an open tank, a sewer system, an industrial wastewater supply, and so on.

The term “catalytic reactor” as used herein refers to a process vessel used to carry out a chemical reaction, in presence of catalysts, under appropriate process variables. In this regard, the catalytic reactor enables bringing reactants into intimate contact with active sites on the catalyst under appropriate process variables such as temperature, pressure, flow, the concentration of reactants, and so forth, for adequate time. Furthermore, the rate of a catalytic reaction is proportional to the amount of catalyst the reactants contact, as well as concentrations of the reactants. Additionally, with a solid phase catalyst and a fluid phase reactant (the water and the reactive oxygen species), the rate of a catalytic reaction is proportional to the exposed area, the efficiency of diffusion of reactants, and the efficacy of mixing of the reactants. Optionally, the catalytic reaction may occur in multiple steps using various chemical kinetics with intermediates that are chemically bound to the catalyst. Optionally, the catalytic reaction may be applied in parallel and/or series to increase a capacity and cleanliness of the treated water. Optionally, the catalytic reactor is a packed-bed catalytic reactor comprising at least a bed of catalysts.

Optionally, the catalytic reactor comprises:
a light source for supplying light in an ultraviolet wavelength range of electromagnetic spectrum;
at least one oxidation catalyst selected from: a zinc oxide, a cadmium oxide, a titanium oxide, zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide;
a plurality of inlets for receiving the water, the generated reactive oxygen species, and additional hydrogen peroxide therein; and
an outlet for moving a treated water onwards.

In this regard, optionally, the catalytic reactor employs the light source, supplying light in a range of 10-400 nanometre (nm) (UV wavelength in the electromagnetic spectrum), therein. The light source may be arranged with the catalytic reactor for providing uniform distribution of light therein. The light in the said wavelength range, i.e. the ultra-violet wavelength range, enables effective disinfection of the water by killing the unwanted microorganisms. In this regard, the ultraviolet light when combined with the reactive oxygen species may degrade the most persistent compounds present in the water. Optionally, the light may also act as a catalyst, thereby increasing the rate of the reaction in the catalytic reactor. Optionally, the light source may be a UV lamp. The UV lamp may be placed in one or more than one positions in the catalytic reactor to achieve high oxidation reaction rate between contaminants and reactive oxygen species at the liquid-gas interface.

The term “oxidation catalysts” as used herein refers to catalysts that cause oxidation reactions. In this regard, the oxidation catalysts enable the transfer of oxygen atoms, hydrogen atoms, or electrons, during the catalytic reaction. Beneficially, the oxidation catalysts convert hazardous compounds like volatile organic compounds (VOCs), formaldehyde and other hydrocarbons to non-toxic products like carbon dioxide and water. Additionally, beneficially the use of oxidation catalysts enhances the rate of oxidation (reduces the activation-energy barrier) by adsorbing the oxygen and the hazardous compounds (like VOCs) on its surface.

Optionally, the at least one oxidation catalyst is arranged as a packed-bed catalyst. The term “packed-bed catalyst” as used herein refers to the catalysts used in packed-bed reactors. Typically, the packed-bed catalysts are solid catalyst particles that are used to catalyse liquid-gas reactions in the catalytic reactor. Moreover, the said reactions take place on the surface of the packed-bed catalyst. Advantageously, the packed-bed catalyst enables higher conversion of the reactant molecules per weight of catalyst than other catalytic reactors. Optionally, the water may be pumped into the top of the catalytic reactor and made to flow downward through the packed-bed or vice versa (a preferred embodiment of the present disclosure). Optionally, the generated reactive oxygen species and water may be pumped from the bottom of the catalytic reactor, and allowed to pass through the at least one oxidation catalyst arranged as the packed-bed catalyst in the catalytic reactor, to enable the oxidation of the organic matter contained in the water. Furthermore, the conversion may depend on the amount of the packed-bed catalyst rather than the volume of the catalytic reactor. Notably, the packed-bed catalyst may be formed using a packing material fabricated using materials such as ceramic, metal or glass. It will be appreciated that the at least one oxidizing catalyst is arranged as the packed-bed catalyst to increase hydraulic retention time and interaction contact.

Optionally, the catalytic reactor further comprises at least one reduction catalyst selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide. The term “reduction catalysts” as used herein refers to catalysts that cause reduction reactions. In this regard, the reduction catalysts reduce hazardous compounds like oxides of nitrogen (NOₓ) to non-toxic products like Nitrogen (N₂). Additionally, the at least one reduction catalyst is employed in the catalytic reactor to convert NO₃_{^{−}} (Nitrate ion) to Nitrogen. In an embodiment, the catalytic reactor may include only the at least one oxidation catalyst but does not include catalysts for the reduction reaction. However, in various embodiments, the catalytic reactor may include both the oxidation and the reduction catalysts. Beneficially, having both the at least one oxidation catalyst and the at least one reduction catalyst in the catalytic reactor enhances the breaking down of hazardous compounds to non-toxic compounds, mainly water and carbon dioxide (CO₂).

Optionally, the at least one reduction catalyst is arranged as a packed-bed catalyst. Optionally, the packed-bed catalyst comprising the at least one reduction catalyst may form a structured packing in the catalytic reactor. Optionally, the packed-bed catalyst is porous so that reaction occurs in the pores and may help to improve reaction rate.

Moreover, the catalytic reactor comprises a plurality of inlets for receiving the water, the generated reactive oxygen species, and additional hydrogen peroxide therein. Optionally, the water, the generated reactive oxygen species, and the additional hydrogen peroxide may be injected in a manner such as a batch, a continuous, or a pulsed manner. Optionally, the plurality of inlets may be designed in such a manner that it increases the contact time and the state of mixedness of concentrations of reactants in the catalytic reactor. Optionally, the plurality of inlets may be designed based on the contacting flow pattern (such as co-counter and cross-current) of the water and the generated ROS in the catalytic reactor.

In an implementation, the water and the generated reactive oxygen species are received in the catalytic reactor, comprising the oxidation catalyst, a reduction catalyst and the UV light, at sufficient velocity. In this regard, optionally, the generated reactive oxygen species are diffused into the catalytic reactor via an inlet that is implemented as a diffuser. Typically, the diffuser is applied to generate microbubbles and nanobubbles to increase hydraulic retention time and interaction contact between the water, the generated reactive oxygen species and the catalysts in the catalytic reactor. Optionally, the diffuser may be used to uniformly disperse the stream of the liquid-gas mixture in all the directions inside the catalytic reactor.

It will be appreciated that the generated reactive oxygen species may not provide a sufficient amount of hydroxyl radical for treating the water, such as water having high dissolved content. In this regard, an additional or a direct dose of hydrogen peroxide, from an external source thereof, may be provided into the catalytic reactor by one or more of the at least one input. Optionally, an external source of the hydrogen peroxide may be available in liquid form with several concentrations. It will be appreciated that the additional or a direct dose of hydrogen peroxide (H₂O₂) is fed into the catalytic reactor only if the COD of the water is very high. If the COD is not high, the H₂O₂ generated in the oxidation chamber and supplied to the catalytic chamber is enough to treat the water in the catalytic reactor. Beneficially, the use of generated H₂O₂ in the catalytic reactor, without any additional H₂O₂ fed from outside, helps to save the cost of the overall process, thereby making the overall method cost-efficient. Moreover, optionally, the H₂O₂ is not supplied into the catalytic reactor via a diffuser.

Furthermore, the catalytic reactor comprises the outlet for moving a treated water onwards. Optionally, the outlet may be connected to other process equipment of the water treatment process, such as additional treatment cycles (discussed later) or may directly lead to an end-user.

Optionally, the reactive oxygen species is generated by oxidation of ozone that is produced from a supply of gases comprising oxygen (O₂), in presence of at least one oxidation catalyst and light, and wherein
the light is in an ultraviolet wavelength range of electromagnetic spectrum; and
the at least one oxidation catalyst is at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, wherein
   a first set of the at least one oxidation catalyst and the light, oxidizes ozone to form the reactive oxygen species; and
   a second set of the at least one oxidation catalyst and the light, oxidizes ozone in the presence of a substance comprising hydrogen (H) to form hydrogen peroxide.

The ozone is an inorganic molecule with the chemical formula O₃. Naturally, the ozone is formed from dioxygen (O₂) by the action of ultraviolet (UV) light and electrical discharges within the Earth's atmosphere. The ozone is typically a pale blue gas with a distinctively pungent smell and is much less stable than the diatomic allotrope O₂. Oxidation of ozone enables the ozone molecules to reduce electrons or break into simpler entities, such as oxygen atom and hydroxyl radical, to create an even higher oxidation potential than ozone, useful for water treatment. Beneficially, the increased number of OH— radicals will initiate the advanced oxidation process, thereby causing the dissolved contaminants to be oxidized by both ozone (directly) and OH— radicals (indirectly). Additionally, the high oxidation potential enables the oxygen molecule to react with various organic and inorganic compounds present in the water that may not be easily oxidized by other chemicals.

Moreover, the oxidation of ozone takes place in an oxidization chamber. Optionally, the oxidation chamber may be a hermetically sealed chamber having an inlet for supplying gases comprising ozone (O₃) (or gases comprising oxygen atom (O)), from a supply arrangement thereof, into the oxidization chamber. Besides the input for supplying the ozone or gases comprising oxygen atom, the oxidization chamber comprises at least one oxidation catalyst, a light source for supplying light in an ultraviolet wavelength range of the electromagnetic spectrum, and an outlet for supplying the reactive oxygen species onwards. Optionally, a high voltage source may be used for converting the gases comprising oxygen (O₂) into ozone (O₃) and gases comprising oxygen atom (O). Optionally, the high voltage source may be communicably coupled with an inlet for supplying the ozone and/or gases comprising oxygen atom into the oxidation chamber at one end; and another inlet for supplying gases comprising oxygen (O₂) from a supply arrangement thereof at another end. In this regard, said another inlet supplies gases comprising oxygen (O₂) into the high voltage source for conversion thereof to ozone and gases comprising oxygen atom that are supplied to the oxidation chamber for generation of reactive oxygen species. Beneficially, generating reactive oxygen species within the oxidation chamber before feeding it further onwards, such as into the catalytic reactor, will help reduce the cost of the process.

It will be appreciated that the at least one oxidation catalyst of the oxidation chamber is similar to the at least one oxidation catalyst of the catalytic reactor discussed above. In the oxidation chamber, the at least one oxidation catalyst, along with light, cause oxidation of the oxygen atoms or molecules to generate reactive oxygen species. The light is in an ultraviolet wavelength range of the electromagnetic spectrum that typically ranges from 10-400 nm. Alternatively, optionally, the ROS may be generated rapidly through radiolysis of a substance comprising hydrogen (H) upon ionizing radiation (X-rays, y-rays) or by UV-light irradiation of H₂O₂. Optionally, the at least one oxidation catalyst such as a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, having, different effects on gases comprising oxygen atom (O), preferably ozone (O₃), for generating reactive oxygen species.

The first set of at least one oxidation catalyst and the light oxidizes ozone to form reactive oxygen species, such as singlet oxygen. Moreover, the other reactive oxygen species may be ozonide radical anion (O⁻₃), superoxide anion, and so forth. Optionally, the first set of at least one oxidation catalyst may include ZnO and TiO₂ support on cray. The second set of at least one oxidation catalyst and the light oxidizes ozone in the presence of substance comprising hydrogen (H) to form hydrogen peroxide and other reactive oxygen species. Optionally, the second set of at least one oxidation catalyst may include the iron oxide support on cray, the UV light, and substance comprising hydrogen in the fed gases comprising oxygen atom, preferably ozone (O₃), the hydrogen peroxide is produced. Beneficially, the generated hydrogen peroxide is then introduced into the catalytic reactor, without any additional hydrogen peroxide fed from the external source, thereby saving the cost, if the COD of the water is low. It will be appreciated that the reactive oxygen species produced from oxidation reaction by the second set of at least one oxidation catalyst, such as iron oxide support on cray, is not much as compared to the reactive oxygen species produced from oxidation reaction by the first set of at least one oxidation catalyst, such as ZnO and TiO₂.

Optionally, the water is pre-treated prior to receiving it in the catalytic reactor, and wherein the water is pre-treated using a dissolved air flotation technique or a filtration technique. The term “pre-treated” as used herein refers to a pre-treatment before the catalytic treatment of water in the catalytic reactor. In this regard, the water is pre-treated to decreased levels of toxic metal ions, disease-causing microbes, organic and inorganic compounds in sludge form therein.

Optionally, a dissolved air flotation technique is used for pre-treating the water. The term “dissolved air flotation technique”, shortly called DAF as used herein refers to a water treatment process that dissolves air in the water under high pressure and then releases the supplied air at atmospheric pressure into a dissolved air flotation arrangement. Moreover, the supplied air forms tiny bubbles (macrobubbles or microbubbles) that adhere to the suspended matter present in the water and cause the suspended matter to float to the surface of the water. The DAF technique is typically used to remove suspended solids, fats, oils, greases and non-soluble organics from the water, such as wastewater or water of variable COD/BOD/TOC. Typically, the water flows through the pipe in the floatation tank, the floatation tank is designed to provide chemicals such as coagulant into the stream of water to break the emulsion thereof. Furthermore, multiple ports are installed throughout the pipe allowing sampling the water in a series of locations and providing addition for chemicals if required. The DAF comprises a pump to dissolve the air into the supplied water to allow maximum adhesion to the particles. The micro (or macro) air bubbles attached to the lighter particles cause them to rise to the surface, and the heavier floating particles settle down onto the discharge cones. The treated water exits the DAF while the floating waste particle is skimmed off the top and into the sludge collector. Optionally, the dissolved air flotation technique generates air bubbles into the system thereby increasing the surface contact of the air bubble to the organic and inorganic compounds in the water. Moreover, the air bubble enables the organic and inorganic compounds to form an emulsion or scum and float on the surface of the water, that is then separated from the surface of the water.

Optionally, the dissolved air flotation technique is a nano dissolved air flotation technique. The term “nano dissolved air flotation technique” as used herein refers to the dissolved air flotation technique that uses nano-sized bubbles to treat the water. Typically, the nanobubbles may be of below 5000 nanometres (nm) in size. Moreover, the nanobubbles may be formed using any gas supplied into the water. Optionally, the nanobubbles may be below 1000 nm, below 500 nm, below 100 nm, for example. Beneficially, due to the size of the bubble, the nano dissolved air flotation technique exhibits properties that improve physical, chemical, and biological processes. In this regard, the nano dissolved air flotation technique increases the surface contact of the nanobubbles with the water, thereby increasing the biological activity of bio enzymes, removing toxins and inhibiting the algae growth. Furthermore, the nanobubbles reduce the size of the dissolved air flotation arrangement, thereby reducing design and operational costs as well.

The method further comprises subjecting the treated water to at least one of: an additional dissolved air flotation arrangement and an aerobic reactor, for producing clean water. It will be appreciated that the additional dissolved air flotation arrangement is similar to the dissolved air flotation arrangement discussed above. The additional dissolved air flotation arrangement improves the quality of water, i.e. by further treating the treated water that is onwards from the catalytic reactor, for use by humans, animals and plants. The term “aerobic reactor” as used herein refers to an arrangement for carrying out a chemical (or biochemical) process in the presence of oxygen, wherein the oxygen functions as a terminal electron acceptor. Typically, the aerobic reactor consists of an agitator, a baffle, a sparger, and a jacket for providing different physiological conditions required for the chemical (or biochemical) process. Optionally, the aerobic reactor may be used for biological water treatment to enable assimilation of organic matter and dissolved nutrients in the treated water and removing (or limiting) the soluble component from the treated water. Notably, the oxygen present acts as an electron acceptor when oxidizing the organic matter that leads to high energy yields and significant production of sludge, resulting from the high growth of bacteria under aerobic conditions. Additionally, the aerobic reactor consists of disinfection processes for removing or inactivating pathogenic or any other living microorganisms to ensure the treated water is clean, odourless and can be reused. Optionally, the said chemical process may be governed by several factors such as temperature, enzymes, pH, macro- and micronutrients, gas-to-liquid mass transfer and trace elements in the water. Optionally, a minimal critical concentration of dissolved oxygen may be maintained in the substrate to keep the microorganisms active. Optionally, the aerobic reactor may be a simple designed open lagoon or an oxidation pond, a mechanically stirred tank reactor, a fixed bed reactor, and the like. The treated water received from the catalytic reactor is then passed through to the aerobic reactor for further treatment to produce clean water. Optionally, the aerobic reactor may be arranged in series or in parallel to produce clean water. Moreover, the aerobic reactor may be applied in series for obtaining the most minimize COD values. Furthermore, the aerobic reactor may be applied in parallel to increase the volume of clean water obtained after the water treatment process.

The term “clean water” as used herein refers to treated water obtained after the completion of the water treatment process as an end product. In this regard, the treated water is clean and may have about 60 to 80% BOD reduction and may achieve BOD below 20 mg/l. Moreover, the chemical oxygen demand (COD) is an estimation of oxygen consumed by the water as a result of bacterial action. Optionally, the biochemical oxygen demand (BOD) of the clean water is reduced sufficiently to render the contaminated water fit for reuse. Optionally the clean water may have the COD below 120 mg/l. Moreover, the clean water has reduced suspended solid and about 90 to 99% reduced level of bacteria and other pathogens. Optionally, the clean water may be high-quality clean water. The high-quality clean water may have no or low bacteria, less contamination of all inorganic and organic substances to be able to use for household and industrial consumption (such as for food production).

In an implementation, the method and the system for water treatment using modified advanced oxidizing technology may be used for applications having fewer toxins and soluble substances in the water. Moreover, the method may be used in a swimming water treatment process, a fruits or vegetables toxic destruction, water supply reservoir, and the like. Additionally, the method may be applied for applications that require high quality of water. It will be appreciated that the source of water for such applications will have a significantly reduced COD/BOD/TOC in the water. Therefore, said applications may not require the pretreatment or post-treatment steps using the DAF, aerobic treatment step, or any other additional step apart from the catalytic treatment of water.

The present disclosure also relates to the system as described above. Various embodiments and variants disclosed above apply mutatis mutandis to the system.

It will be appreciated that the catalytic reactor is operatively coupled to the supply of water and the oxidization chamber, for receiving the water and the generated reactive oxygen species for treating the water. It will be appreciated that the water and the generated reactive oxygen species are received in the catalytic reactor in batches or continuously.

Optionally, the system further comprises a dissolved air flotation arrangement or a filtration arrangement, coupled to the supply of water, for pre-treating the supplied water.

Optionally, the dissolved air flotation technique is a nano dissolved air flotation technique.

Optionally, the oxidization chamber generates the reactive oxygen species by oxidation of ozone, that is produced from a supply of gases comprising oxygen (O₂), in presence of at least one oxidation catalyst and light, and wherein the oxidization chamber comprises:
an inlet for supplying gases comprising oxygen atom (O), preferably ozone (O₃), into the oxidization chamber;
a light source for supplying light in an ultraviolet wavelength range of electromagnetic spectrum;
at least one oxidation catalyst selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, wherein
   a first set of the at least one oxidation catalyst and the light, oxidizes ozone to form the reactive oxygen species; and
   a second set of the at least one oxidation catalyst and the light, oxidizes ozone in the presence of substance comprising hydrogen (H) to form hydrogen peroxide; and
an outlet for supplying the reactive oxygen species onwards.

Optionally, the catalytic reactor comprises:
a light source for supplying light in an ultraviolet wavelength range of electromagnetic spectrum;
at least one oxidation catalyst arranged as a packed-bed catalyst;
a plurality of inlets for receiving the water, the generated reactive oxygen species, and additional hydrogen peroxide therein; and
an outlet for moving a treated water onwards.

Optionally, the at least one oxidation catalyst is selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide.

Optionally, the catalytic reactor further comprises at least one reduction catalyst selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide.

Optionally, the at least one reduction catalyst is arranged as a packed-bed catalyst.

Optionally, the inlet for receiving the generated reactive oxygen species is implemented as a diffuser, wherein the diffuser diffuses the received generated reactive oxygen species into the catalytic reactor.

Optionally, the system further comprises at least one of: an additional dissolved air flotation arrangement, and an aerobic reactor for treating the treated water for producing clean water.

### DETAILED DESCRIPTION OF THE DRAWINGS

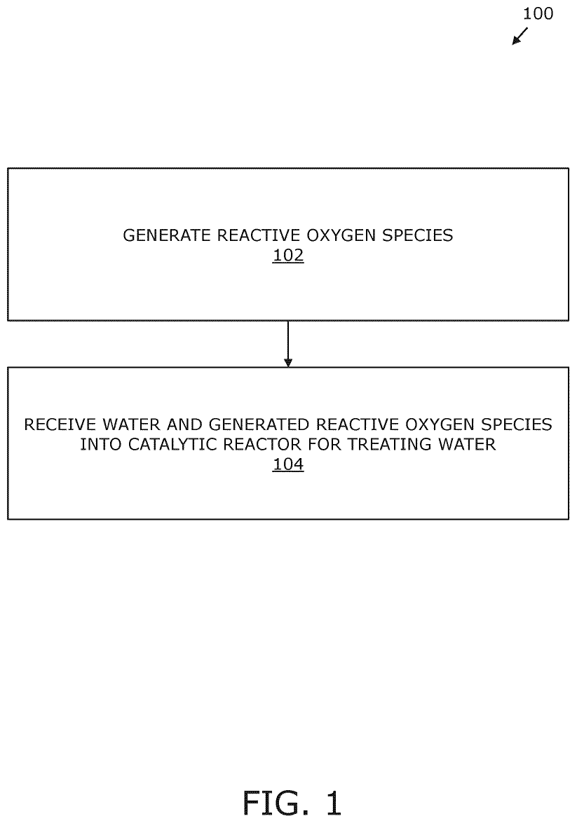

Referring to FIG. 1, illustrated is a flowchart 100 illustrating steps of a method for a water treatment using a modified advanced oxidizing technology, in accordance with an embodiment of the present disclosure. At step 102, reactive oxygen species are generated. At step 104, a water and the generated reactive oxygen species are received into a catalytic reactor for treating water. Moreover, at step 102, hydrogen peroxide is also generated, in addition to other reactive oxygen species, in the presence of oxidation catalyst and light.

The steps 102 and 104 are only illustrative and other alternatives can also be provided where one or more steps are added, one or more steps are removed, or one or more steps are provided in a different sequence without departing from the scope of the claims herein.

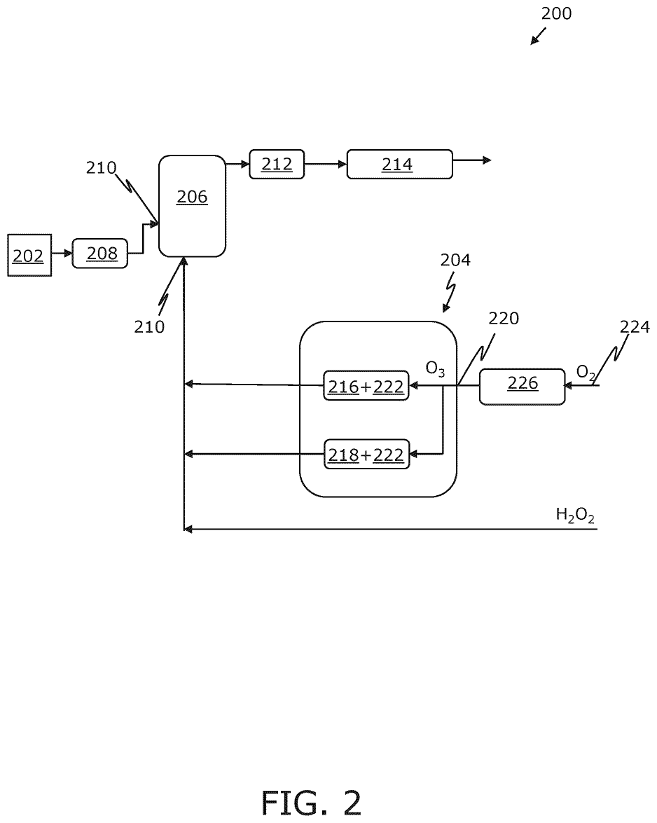

Referring to FIG. 2, illustrated is a block diagram of a system 200 for a water treatment using an advanced oxidizing technology, in accordance with an embodiment of the present disclosure. The system 200 comprises a supply of water 202 to provide water and an oxidization chamber 204 for generating reactive oxygen species and hydrogen peroxide. The system 200 comprises a catalytic reactor 206, operatively coupled to the supply of water 202 and the oxidization chamber 204, for receiving the water and the generated reactive oxygen species for treating the water. Moreover, the system 200 comprises a dissolved air flotation arrangement (or a filtration arrangement) 208, coupled to the supply of water 202, for pre-treating the supplied water. The system 200 comprises a plurality of inlets, such as the inlet 210, into the catalytic reactor 206 for supplying water, the generated reactive oxygen species, and other inputs (such as additional hydrogen peroxide) into the catalytic reactor 206. The system 200 further comprises at least one of: an additional dissolved air flotation arrangement 212, and an aerobic reactor 214 for treating the treated water for producing clean water.

As shown, the oxidization chamber 204 generates the reactive oxygen species by oxidation of ozone, that is produced from a supply of gases comprising oxygen (O₂), in presence of at least one oxidation catalyst, such as a first set of the at least one oxidation catalyst 216 and a second set of the at least one oxidation catalyst 218, and light. Moreover, the oxidization chamber 204 comprises an inlet 220 for supplying gases comprising oxygen atom (O), preferably ozone (O₃), into the oxidization chamber 204, a light source 222 for supplying light in an ultraviolet wavelength range of the electromagnetic spectrum, at least one oxidation catalyst, such as a first set of the at least one oxidation catalyst 216 and a second set of the at least one oxidation catalyst 218, and an outlet 210 for supplying the reactive oxygen species onwards. It will be appreciated that the supply of gases comprising oxygen (O₂) is first supplied via another inlet 224 to a high voltage source 226 as shown. As shown, the inlet 220 is separated from another inlet 224. Notably, the high voltage source 226 may be used for converting the gases comprising oxygen (O₂) into ozone (O₃). In this regard, the high voltage source 226 may be communicably coupled to the inlets 220 and 224 at separate ends thereof. Optionally, the inlet 224 may be used to supply O₂ to the high voltage source 226 so that the O₂ is converted into the ozone therein and then passed via the inlet 220 into the oxidation chamber 204.

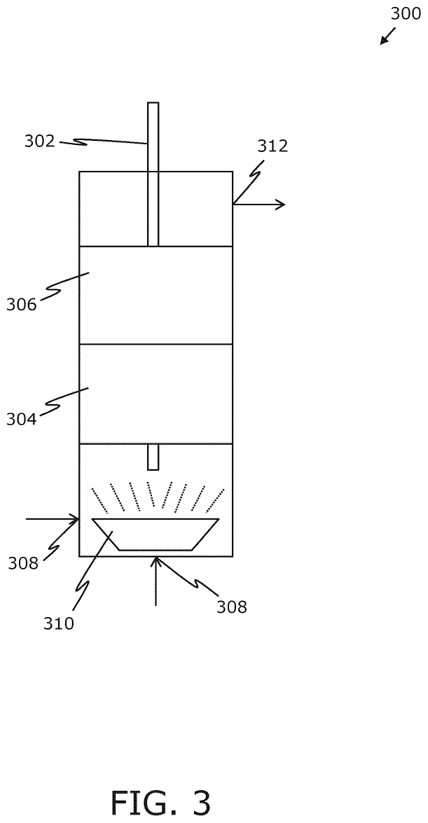

Referring to FIG. 3, illustrated is a schematic illustration of the catalytic reactor 300, in accordance with an embodiment of the present disclosure the catalytic reactor 300 comprises at least one of a light source 302 for supplying light in an ultraviolet wavelength range of electromagnetic spectrum and at least one of oxidation catalysts 304 arranged as a packed-bed catalyst. Additionally, the catalytic reactor further comprises at least one reduction catalyst 306 arranged as a packed-bed catalyst. Moreover, the catalytic reactor 300 comprises a plurality of inlets, such as the inlet 308, for receiving the water, the generated reactive oxygen species, and additional hydrogen peroxide therein. It will be appreciated that the at a plurality of inlets, such as the inlet 308, is implemented as a diffuser 310 for supplying (by diffusing) the generated reactive oxygen species into the catalytic reactor 300. Furthermore, the catalytic reactor 300 comprises an outlet 312 for moving a treated water onwards.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for a water treatment using a modified advanced oxidizing technology, the method comprising:
generating reactive oxygen species; and
receiving a water and the generated reactive oxygen species into a catalytic reactor for treating water,
wherein the reactive oxygen species is generated by oxidation of ozone that is produced from a supply of gases comprising oxygen (O₂), in presence of at least one oxidation catalyst and light, and wherein
the light is in an ultraviolet wavelength range of electromagnetic spectrum; and
the at least one oxidation catalyst is at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide.

2. The method according to claim 1, wherein the water is pre-treated prior to receiving it in the catalytic reactor, and wherein the water is pre-treated using a dissolved air flotation technique or filtration technique.

3. The method according to claim 2, wherein the dissolved air flotation technique is a nano dissolved air flotation technique.

4. The method according to claim 1, wherein
a first set of the at least one oxidation catalyst and the light, oxidizes ozone to form the reactive oxygen species; and
a second set of the at least one oxidation catalyst and the light, oxidizes ozone in the presence of a substance comprising hydrogen (H) to form hydrogen peroxide.

5. The method according to claim 1, wherein the reactive oxygen species is at least one of: Superoxide anion, Hydroxyl radical, Hydroxyl ion, Peroxyl radical, Alkoxyl radical, Hydroperoxyl radical, Perhydroxyl radical, Peroxide radical, Hydrogen peroxide, Singlet oxygen.

6. The method according to claim 1, wherein the catalytic reactor comprises:
a light source for supplying light in an ultraviolet wavelength range of electromagnetic spectrum;
at least one oxidation catalyst selected from: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide;
a plurality of inlets for receiving the water, the generated reactive oxygen species, and additional hydrogen peroxide therein; and
an outlet for moving a treated water onwards.

7. The method according to claim 6, wherein the at least one oxidation catalyst is arranged as a packed-bed catalyst.

8. The method according to claim 6, wherein the catalytic reactor further comprises at least one reduction catalyst selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide.

9. The method according to claim 8, wherein the at least one reduction catalyst is arranged as a packed-bed catalyst.

10. The method according to claim 1, further comprising subjecting the treated water to at least one of: an additional dissolved air flotation arrangement, and an aerobic reactor, for producing clean water.

11. A system for a water treatment using a modified advanced oxidizing technology, the system comprising:
a supply of water;
an oxidization chamber for generating reactive oxygen species; and
a catalytic reactor, operatively coupled to the supply of water and the oxidization chamber, for receiving the water and the generated reactive oxygen species for treating the water,
wherein the oxidization chamber generates the reactive oxygen species by oxidation of ozone, that is produced from a supply of gases comprising oxygen (O₂), in presence of at least one oxidation catalyst and light, and wherein the oxidization chamber comprises:
an inlet for supplying gases comprising ozone (O₃) into the oxidization chamber;
a light source for supplying light in an ultraviolet wavelength range of electromagnetic spectrum;
at least one oxidation catalyst selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide; and
an outlet for supplying the reactive oxygen species onwards.

12. The system according to claim 11, further comprising a dissolved air flotation arrangement or a filtration arrangement, coupled to the supply of water, for pre-treating the supplied water.

13. The system according to claim 12, wherein the dissolved air flotation technique is a nano dissolved air flotation technique.

14. The system according to claim 11,
a first set of the at least one oxidation catalyst and the light, oxidizes ozone to form the reactive oxygen species; and
a second set of the at least one oxidation catalyst and the light, oxidizes ozone in the presence of a substance comprising hydrogen (H) to form hydrogen peroxide.

15. The system according to claim 11, wherein the catalytic reactor comprises:
a light source for supplying light in an ultraviolet wavelength range of electromagnetic spectrum;
at least one oxidation catalyst arranged as a packed-bed catalyst;
a plurality of inlets for receiving the water, the generated reactive oxygen species, and additional hydrogen peroxide therein; and
an outlet for moving a treated water onwards.

16. The system according to claim 15, wherein the at least one oxidation catalyst is selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide.

17. The system according to claim 15, wherein the catalytic reactor further comprises at least one reduction catalyst selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide.

18. The system according to claim 17, wherein the at least one reduction catalyst is arranged as a packed-bed catalyst.

19. The system according to claim 15, wherein the inlet for receiving the generated reactive oxygen species is implemented as a diffuser, wherein the diffuser diffuses the received generated reactive oxygen species into the catalytic reactor.

20. The system according to claim 11, further comprising at least one of: an additional dissolved air flotation arrangement, and an aerobic reactor for treating the treated water for producing clean water.
